(19) United States
(12) Patent Application Publication
(10) Pub. No.: US 2007/0038585 A1
(43) Pub. Date: Feb. 15, 2007

(54) Method for simulating a response to a stimulus

(75) Inventors: Glen A. Thommes, Wilmington, DE (US); Jeffrey L. Thommes, Wilmington, DE (US)

Correspondence Address: Thomas R. Lane, 110 Gideon Drive, Kennett Square, PA, 19348, US

(73) Assignee: Thommes Family, LLC

(21) Appl. No.: 11/204,211

(22) Filed: Aug. 15, 2005

(51) Int. Cl. G06F 15/00

(52) U.S. Cl. 706/10

(57) ABSTRACT

A method of simulating a response to a stimulus is disclosed. In one embodiment, the method includes modeling the response with at least one differential equation, and executing instructions on a machine to numerically integrate the differential equation. The differential equation includes a parameter that depends on the fraction of the response that has occurred.

### BACKGROUND

1. Field

The present disclosure pertains to the field of computer simulation and, more specifically, to the field of computer optimization of stimulus-response systems and processes, such as the radiation curing of a photosensitive coating.

2. Description of Related Art

The analysis of systems and processes in which a response is caused by a stimulus is often complicated by the multiplicity of parameters that influence the response, including parameters that depend on the progress of the response while it is occurring. For example, a stimulus in the form of radiation may be used to cure a photosensitive coating on a substrate. In this system, the response, the polymerization of the coating, is influenced by many parameters, including the wavelength and intensity of the radiation, the time that the coating is exposed to the radiation, the quantum yield and kinetic chain length of the polymerization reaction, the actinic absorbance, non-actinic absorbance, radiation scattering by particulates, viscosity, and thickness of, and the solubility of oxygen and its diffusion coefficient, the reflectivity of the substrate in the actinic spectral regions, and the presence of immobile inhibitors and their concentration in the coating, and the presence or absence of atmospheric oxygen. Moreover, certain parameters may change during the course of the photoreaction, for example, the absorbance of the coating may change if the absorption coefficient of the product of the photoreaction is different than that of the original formulation.

A previous approach to analyzing and optimizing these systems and processes has been to use trial and error experimentation over various ranges of each parameter. Even with the use of statistical design-of-experiment techniques and the insight of scientists experienced and skilled in the art, the number of experiments necessary to yield valuable results may be quite large if the number and range of different parameters is large. In turn, the large number of experiments leads to a high cost of materials, manpower, time, and equipment usage, and a greater potential for errors or suboptimal results due to repeatability or other experimental issues.

### BRIEF DESCRIPTION OF THE FIGURES

The present invention is illustrated by way of example in, and is not limited by, the Figures of the accompanying drawings.

FIG. 1 illustrates a photoreactive curing system useful for describing one embodiment of the invention.

FIG. 2 illustrates a characteristic curve for a photoreaction.

FIG. 3 illustrates an embodiment of the invention in a method for simulating a response to a stimulus.

### DETAILED DESCRIPTION

The following describes embodiments of a method for simulating a response to a stimulus. In the following description, numerous specific details, such as the details of a particular stimulus-response system, are set forth in order to provide a more thorough understanding of the invention. It will be appreciated, however, by one skilled in the art, that the invention may be practiced without such specific details. Additionally, to avoid unnecessarily obscuring the invention, some well-known concepts, such as the Beer-Lambert law, have not been shown in detail.

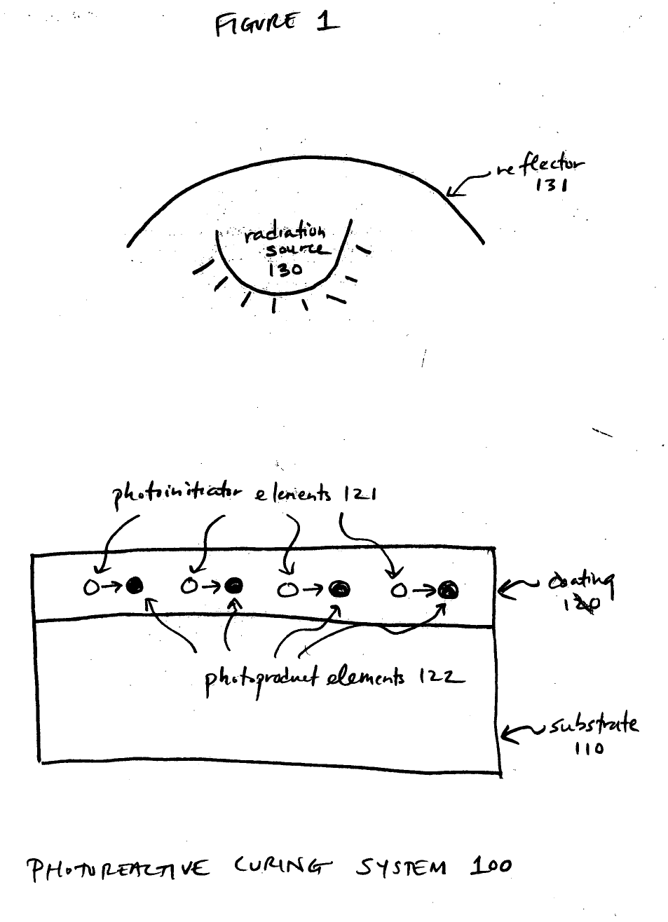

FIG. 1 illustrates photoreactive curing system 100, which is useful for describing one embodiment of the invention. Substrate 110 is covered with photosensitive coating 120 and exposed to radiation source 130, which may be augmented by reflector 131. Photosensitive coating 120 contains photoinitiator elements 121, which are actinic absorbers that initiate a photoreaction upon their exposure to and absorption of radiation. The photoreaction may be photopolymerization or any other photoreaction that affects photosensitive coating 120, such as by giving it discernable physical properties or appearance differences useful in protecting substrate 110 or in defining stimulated areas from non-stimulated areas or volumes. As a result of the photoreaction, photoinitiator elements 121 are converted to photoproduct elements 122. Photoproduct elements 122 may themselves affect photosensitive coating 120, or they may be a byproduct of the photoreaction that affects photosensitive coating 120.

The rate of the photoreaction is proportional to the intensity of the radiation, which is greatest at the surface of photosensitive coating 120 and decreases exponentially with depth in accordance with the Beer-Lambert law. Therefore, the concentration of photoproduct element 122 is initially greatest at the surface. Photoproduct elements 122 are of interest because they may absorb more, less, or the same amount of radiation as photoinitiator elements 121. In the first case, the amount of radiation that penetrates photosensitive coating 120 will be reduced by the “shadowing” effect of photoproduct elements 122 at the surface, and the photoreaction will be inhibited as it progresses. In the second case, the amount of radiation that penetrates photosensitive coating 120 will be increased by the “windowing” or “bleaching” effect of photoproduct elements 122 at the surface, and the photoreaction will be assisted as it progresses. In the third case, there will be neither of these effects.

The shadowing and bleaching effects will vary from one wavelength of the radiation to another, depending on the absorbance characteristics of the photoinitiator elements and the corresponding photoproduct elements. Thus, in one wavelength region, shadowing may occur as the exposure proceeds, in another, bleaching may occur, and in other regions there may not be either effect.

Additionally, two types of absorbance may occur in photosensitive coating 120. These two types may be described as actinic absorbance and non-actinic absorbance. Actinic absorbance leads to photoreaction as described above. Non-actinic absorbance does not lead to photoreaction but does contribute to the attenuation of radiation with depth in the coating in the same fashion as the actinic absorbance does. However, it will be a constant contributor to attenuation of radiation of radiation and will not vary with time of irradiation or extent of reaction.

Photoreactive curing system 100 may be modeled with the following equation:

$${\sum }_{{λ}_{min} nm}^{{λ}_{max} nm} ( ⅆ {R}^{λ} / ⅆ T ) = {\sum }_{{λ}_{min} nm}^{{λ}_{max} nm} ( {r}_{e} ) ( {ϕ}^{λ} ) ( {P}_{e}^{λ} ) ,$$

where
   dR^{λ}/dT is the rate of the response per unit volume per unit time at wavelength λ,
   rₑ is a measure of the response per effective photoactive event,
   φ^{λ} is the number of photoactive events per photon effectively absorbed (the “quantum yield” or “chemical efficiency”) at wavelength λ (φ may be a function of wavelength if more than one photoinitiator is used), and
   Pₑ^{λ} is the number of photons effectively absorbed per unit volume per unit time at wavelength λ.

Furthermore:

$${\sum }_{{λ}_{min} nm}^{{λ}_{max} nm} {P}_{e}^{λ} = {\sum }_{{λ}_{min} nm}^{{λ}_{max} nm} ( {I}_{O}^{λ} / {hv}^{λ} ) {F}_{e}^{λ} ,$$

where
   I_{O}^{λ} is the intensity of the incident radiation at wavelength λ,
   h is Planck's constant,
   ν^{λ} is the frequency of the incident radiation, and
   Fₑ^{λ} is the fraction of the incident radiation effective in initiating a photoactive event (the “physical efficiency”) at wavelength λ.

The physical efficiency may be modeled by considering the absorbance of photosensitive coating 120. If the molar absorption coefficient of photoproduct element 122 is the same as the molar absorption coefficient of photoinitiator element 121, then:

$${\sum }_{{λ}_{min} nm}^{{λ}_{max} nm} {A}^{λ} = {\sum }_{{λ}_{min} nm}^{{λ}_{max} nm} {μ}_{A}^{λ} c = {\sum }_{{λ}_{min} nm}^{{λ}_{max} nm} {A}_{0}^{λ} ,$$

where
   A^{λ} is the absorbance per unit length at wavelength λ (or per unit volume if unit area exposure is being considered),
   μ_{A}^{λ} is the molar absorption coefficient of photoinitiator element 121 at wavelength λ,
   c is the molar concentration of photoinitiator element 121, and
   A₀^{λ}=μ_{A}^{λ}c.

However, where the molar absorption coefficients of the photoinitiator and photoproduct differ, the absorbance is given by:

$$\begin{matrix}{\sum }_{ {λ}_{ min} nm}^{ {λ}_{ max} nm} {A}^{ λ} = {\sum }_{ {λ}_{ min} nm}^{ {λ}_{ max} nm} ( {μ}_{ A}^{ λ} c - {f}_{ r} {μ}_{ A}^{ λ} c + {f}_{ r} {μ}_{ A}^{ λ} c ( {μ}_{ P}^{ λ} / {μ}_{ A}^{ λ} ) ) \\ = {\sum }_{ {λ}_{ min} nm}^{ {λ}_{ max} nm} {A}_{0}^{λ} ( 1 - {f}_{r} + {f}_{r} {γ}^{λ} )\end{matrix}$$

where
   fᵣ is the fraction of the photoreaction that has occurred,
   μ_{P}^{λ} is the molar absorption coefficient of photoproduct element 122, and
   γ^{λ}=μ_{P}^{λ}/μ_{A}^{λ}.

In this embodiment, fᵣ is the fraction of the photoinitiator that has reacted, in other words, the number of photoinitiator molecules reacted divided by the total initial number of photoinitiator molecules. This fraction is approximately equal to the fraction polymerized (i.e., the number of volume elements polymerized divided by total number of volume elements) divided by the kinetic chain length of the polymerization reaction. In other embodiments, there may be more than one fraction of reaction involved, each of which, individually or jointly, may affect the response desired or measured.

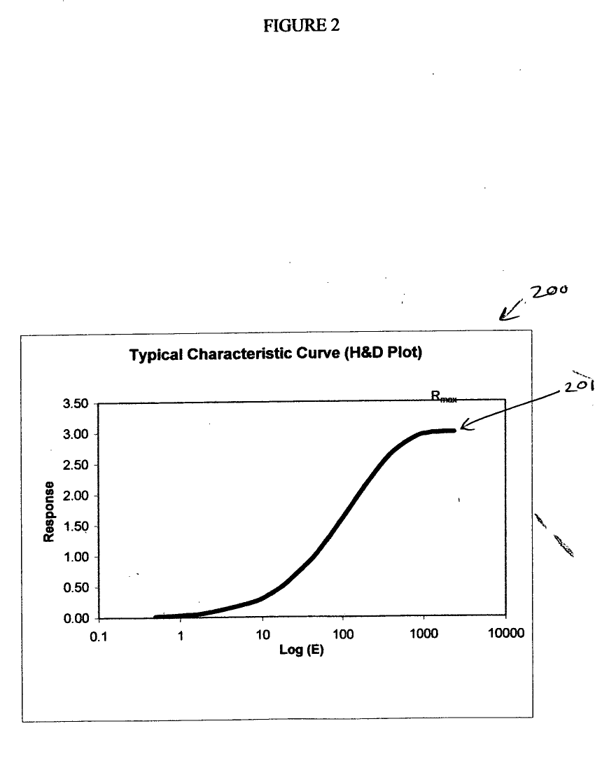

FIG. 2 is an illustration of a characteristic curve for a photoreaction, which is useful in describing an example of the term for the fraction of a photoreaction that has occurred. In FIG. 2, plot 200 is an “H&D” plot as known in the art of black and white photography. The stimulus is plotted on the X axis as the log of the incident energy to which a photoreactive film is exposed. The incident energy is the product of the intensity of the radiation and the time of exposure integrated over the wavelength region of interest. The response to the stimulus is a change to the silver density of the film, a measure of which is plotted on the Y axis. In FIG. 2, the response at point 201 is the maximum detectable response (Rₘₐₓ). The fraction of reaction at any given exposure, then, is the ratio of the response at that exposure divided by the maximum detectable response.

In some embodiments of the invention, a number of discernable levels of the fraction of response may be determined. For example, where the minimum detectable response is 0.01, and the maximum detectable response is 3.00, the first discernable fraction of response may be calculated as 0.01 divided by 3.00, or 0.00333, and the number of discernable levels of fraction of response may be calculated as 3.00 divided by 0.01, or 300.

In some embodiments, the system response is composed of individual responses of a number of responding elements. In these embodiments, the response may be modeled as the product of the response of a single element and the number of responding elements, and the maximum detectable response may be modeled as the product of the response of a single element and the number of elements available to respond. For example, the response of photoreactive system 100 may be modeled as the product of the individual response of a photoinitiator element 121 and the number of photoinitiator elements 121 in photoreactive system 100.

Returning to photoreactive system 100, if the only absorption by photosensitive coating 120 is actinic in nature and results from photoactive materials such as, in this embodiment, photoinitator elements 121, then, according to the Beer-Lambert law, the radiation transmitted to depth L of photosensitive coating 120 is given by:

$${\sum }_{ {λ}_{ min} nm}^{ {λ}_{ max} nm} {I}_{T}^{λ} = {\sum }_{ {λ}_{ min} nm}^{ {λ}_{ max} nm} {I}_{O}^{λ} exp ( - {A}^{λ} L )$$

However, in some embodiments, a coating may contain other materials that may attenuate the radiation in non-actinic fashion by absorption or scattering loss. These non-actinic attenuators may be defined as having absorbance per unit length (or unit volume if unit area exposure is being considered) of N^{λ}. Then, the radiation transmitted to depth L is given by:

$${\sum }_{ {λ}_{ min} nm}^{ {λ}_{ max} nm} {I}_{T}^{λ} = {\sum }_{ {λ}_{ min} nm}^{ {λ}_{ max} nm} {I}_{O}^{λ} exp ( - ( {A}^{λ} + {N}^{λ} ) L )$$

Therefore, the radiation absorbed is given by:

$${\sum }_{ {λ}_{ min} nm}^{ {λ}_{ max} nm} {I}_{A}^{λ} = {\sum }_{ {λ}_{ min} nm}^{ {λ}_{ max} nm} ( {I}_{O}^{λ} - {I}_{T}^{λ} ) = {\sum }_{ {λ}_{ min} nm}^{ {λ}_{ max} nm} {I}_{O}^{λ} ( 1 - exp ( - ( {A}^{λ} + {N}^{λ} ) L ) ) .$$

Continuing, and using the expression for the absorbance (and attenuation) found above, the fraction of the incident radiation absorbed initially (at “time zero”) is:

$${\sum }_{ {λ}_{ min} nm}^{ {λ}_{ max} nm} {F}_{t}^{λ} = {\sum }_{ {λ}_{ min} nm}^{ {λ}_{ max} nm} {I}_{A}^{λ} / {I}_{O}^{λ} = {\sum }_{ {λ}_{ min} nm}^{ {λ}_{ max} nm} ( 1 - exp {{( - ( {A}_{0}^{λ} + {N}^{λ} ) L ) )}^{{λ}_{max} nm}}_{{λ}_{min} nm} ,$$

As exposure time elapses and the reaction occurs, the fraction of the incident radiation absorbed depends on the fraction of reaction as follows:

$$\begin{matrix}{\sum }_{ {λ}_{ min} nm}^{ {λ}_{ max} nm} {F}_{ t}^{ λ} = {\sum }_{ {λ}_{ min} nm}^{ {λ}_{ max} nm} {I}_{ A}^{ λ} / {I}_{ O}^{ λ} \\ = {\sum }_{ {λ}_{ min} nm}^{ {λ}_{ max} nm} ( 1 - exp ( - ( {A}_{ 0}^{ λ} ( 1 - {f}_{ r} + {f}_{ r} {γ}^{ λ} ) + {N}^{ λ} ) L ) ) .\end{matrix}$$

This fraction of the incident radiation absorbed is partially effective in initiating the photoreaction and partially ineffective, depending on the fraction of the photoreaction that has already occurred in a given volume of photosensitive coating 120 and the ratio of the absorption coefficients. Therefore, it may be expressed as:

$${\sum }_{ {λ}_{ min} nm}^{ {λ}_{ max} nm} {F}_{t}^{λ} = {\sum }_{ {λ}_{ min} nm}^{ {λ}_{ max} nm} ( {F}_{e}^{λ} + {F}_{i}^{λ} ) ,$$

where
   Fₑ^{λ} is the fraction effective (the physical efficiency) at wavelength λ, and
   Fᵢ^{λ} is the fraction ineffective at wavelength λ.

The fraction ineffective is that which has already reacted, and is given by:

$${\sum }_{{λ}_{min} nm}^{{λ}_{max} nm} {F}_{i}^{λ} = {\sum }_{{λ}_{min} nm}^{{λ}_{max} nm} ( 1 - exp ( - {f}_{r} {A}_{0}^{λ} ( 1 - {f}_{r} + {f}_{r} {γ}^{λ} ) + {N}^{λ} ) L ) .$$

Therefore, the fraction effective is:

$$\begin{matrix}{\sum }_{{λ}_{min} nm}^{{λ}_{max} nm} {F}_{e}^{λ} = {\sum }_{{λ}_{min} nm}^{{λ}_{max} nm} ( {F}_{t}^{λ} - {F}_{i}^{λ} ) \\ = {\sum }_{{λ}_{min} nm}^{{λ}_{max} nm} ( 1 - exp ( - {A}_{0}^{λ} ( 1 - {f}_{r} + {f}_{r} {γ}^{λ} ) + {N}^{λ} ) L ) - \\ {\sum }_{{λ}_{min} nm}^{{λ}_{max} nm} ( 1 - exp ( - {f}_{r} {A}_{0}^{λ} ( 1 - {f}_{r} + {f}_{r} {γ}^{λ} ) + {N}^{λ} ) L ) \\ = {\sum }_{{λ}_{min} nm}^{{λ}_{max} nm} exp ( - ( {f}_{r} {A}_{0}^{λ} ( 1 - {f}_{r} + {f}_{r} {γ}^{λ} ) + {N}^{λ} ) L ) - \\ exp ( - ( {A}_{0}^{λ} ( 1 - {f}_{r} + {f}_{r} {γ}^{λ} ) + {N}^{λ} ) L ) .\end{matrix}$$

In some systems, one may assume that the molar absorption coefficient of photoproduct element 122 is the same as the molar absorption coefficient of photoinitiator element 121 (i.e., γ=1) at all wavelengths involved. Then, the model for physical efficiency collapses to:

$${\sum }_{{λ}_{min} nm}^{{λ}_{max} nm} {F}_{e}^{λ} = {\sum }_{{λ}_{min} nm}^{{λ}_{max} nm} ( - ( {f}_{r} {A}_{0}^{λ} + {N}^{λ} ) L ) - exp ( - ( {A}_{0}^{λ} + {N}^{λ} ) L ) .$$

In this unique case, the differential equation for the rate of response per unit volume per unit time, from above and repeated below, may be analytically integrated.

$${\sum }_{{λ}_{min} nm}^{{λ}_{max} nm} ⅆ {R}^{λ} / ⅆ T = {\sum }_{{λ}_{min} nm}^{{λ}_{max} nm} ( {r}_{e} ) ( {ϕ}^{λ} ) ( ( {I}_{O}^{λ} / {hv}^{λ} ) {F}_{e}^{λ} )$$

In the more general case:

$$\begin{matrix}{\sum }_{{λ}_{min} nm}^{{λ}_{max} nm} ⅆ {R}^{λ} / ⅆ T = {\sum }_{{λ}_{min} nm}^{{λ}_{max} nm} ( {r}_{e} ) ( {ϕ}^{λ} ) ( ( {I}_{O}^{λ} / {hv}^{λ} ) {F}_{e}^{λ} ) \\ = {\sum }_{{λ}_{min} nm}^{{λ}_{max} nm} ( {r}_{e} {ϕ}^{λ} {I}_{O}^{λ} / {hv}^{λ} ) ( exp ( - ( {f}_{r} {A}_{0}^{λ} ( 1 - {f}_{r} + {f}_{r} {γ}^{λ} ) + \\ {N}^{λ} ) L ) - exp ( - ( {A}_{0}^{λ} ( 1 - {f}_{r} + {f}_{r} {γ}^{λ} ) + {N}^{λ} ) L ) )\end{matrix}$$

Recognizing that the fraction reacted, fᵣ, equals the response R at any given time divided by the total response Rₘₐₓ, gives:

$${\sum }_{{λ}_{min} nm}^{{λ}_{max} nm} ⅆ {R}^{λ} / ⅆ T = {\sum }_{{λ}_{min} nm}^{{λ}_{max} nm} ( {r}_{e} {ϕ}^{λ} {I}_{O}^{λ} / {hv}^{λ} ) ( exp ( - ( {f}_{r} {A}_{0}^{λ} ( 1 - ( {R}^{λ} / {R}_{max}^{λ} ) ( 1 + {γ}^{λ} ) ) + {N}^{λ} ) L ) - exp ( - ( {A}_{0}^{λ} ( 1 - ( {R}^{λ} / {R}_{max}^{λ} ) ( 1 + {γ}^{λ} ) + {N}^{λ} ) L ) )$$

Therefore, when γ may not be assumed to equal one, there appears to be no general analytical solution to the integration of this equation. However, it may be numerically integrated on a computer to analyze the system or optimize the response with respect to any particular parameter or parameters. The analysis or optimization may include or enable modeling the sensitivity of the response to any of the parameters or combination of parameters, defining the efficiency of the system or process, controlling the delivery of the stimulus, and comparing, evaluating, or predicting the effectiveness, cost, or benefit of various treatments or parameters.

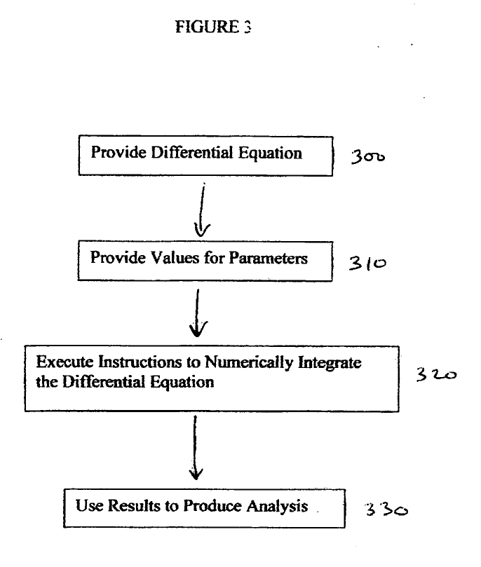

FIG. 3 illustrates an embodiment of the invention in a method for simulating a response to a stimulus. In box 300 of FIG. 3, a differential equation is provided to model a response to a stimulus, where the differential equation includes a parameter that depends on the fraction of the response that has occurred. In box 310, values for the parameters of the differential equation are provided. The parameters may be provided by any characterization of the system and its components, for example, mathematical, chemical, or physical analysis or experimentation. In box 320, instructions are executed by a computer to numerically integrate the differential equation. In box 330, the results of the numerical integration are used to produce an analysis of the stimulus-response system. The analysis may involve or include graphs, charts, reports, data, or any other information or ways to display information, and the evaluation, optimization, prediction, sensitivity analysis, optimization analysis, or any other analysis of any part of the stimulus-response system, including the response or any parameter or other characteristic. For example, the results may be used to produce a variety of datasheets for a chemical formulation, to indicate an improvement to manufacturing line speed, to indicate an optimum photoinitiator or its concentration, to indicate an optimum radiation source, or to indicate an optimization to material or manufacturing cost.

In some embodiments, the response model may also include a range of a parameter that does not depend on the fraction of the response that has occurred. For example, the radiation source in a photoreactive curing system may include a range of wavelengths or frequencies, and the actinic absorbance of the photoactive coating may vary within the range. In this case, the response model may also be numerically integrated over this parameter.

In embodiments where the system response is composed of the individual responses of a number of responding elements, the response of one element may vary from the response of another element, or the response of an individual element may vary within a range of a parameter. In either case, the response model may also be numerically integrated over the range of individual responses.

In some embodiments, values for the model parameters may be stored in a database. In these embodiments, the model or the results of the analysis may be made available for use without disclosing the underlying properties or characteristics of the system or the system components. For example, a chemical formulator or vendor may provide parameters such as photoinitiator molar absorption coefficients to a database, so that potential customers could use the model or the results of the analysis to evaluate the photoinitiators without access to the composition of the photoinitiators or any samples that reverse engineered.

In some embodiments, instructions to cause a computer to numerically integrate the equations that model the response may be stored on any form of a machine-readable medium, with or without the parameter values. An optical or electrical wave modulated or otherwise generated to transmit such information, a memory, or a magnetic or optical storage such as a disc may be the machine-readable medium. Any of these media may “carry” or “indicate” the instructions or the data. When an electrical carrier wave indicating or carrying the instructions or data is transmitted, to the extent that copying, buffering, or re-transmission of the electrical signal is performed, a new copy is made. Thus, a communication provider or a network provider would be making copies of an article (a carrier wave) embodying techniques of the invention.

Thus, techniques for simulating a response to a stimulus are disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. For example, the stimulus may be any exposure to or dose of any radiation, energy, catalyst, enzyme, drug, or any other physical, chemical, electrical, magnetic or other stimulus. The response may be any change in optical density, physical density, solubility, tack, refractive index, resistivity, or any other physical, chemical, electrical, magnetic or other property such as shrinkage or expansion, reactive element conversion, or conversion from liquid to solid or vice versa, of any formulation or medium to through which the stimulus passes or to which the stimulus is otherwise applied. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A method of simulating a response to a stimulus, the method comprising:
modeling the response with at least one differential equation including a first parameter that depends on the fraction of the response that has occurred; and
executing instructions on a machine to numerically integrate the differential equation.

2. The method of claim 1 wherein executing instructions includes numerically integrating the differential equation over a second parameter with respect to which the fraction of the response varies.

3. The method of claim 1 wherein the second parameter is time.

4. The method of claim 1 wherein the second parameter is a spatial dimension.

5. The method of claim 2 wherein executing instructions further includes numerically integrating the differential equation over a third parameter.

6. The method of claim 5 wherein the third parameter depends on the fraction of response that has occurred.

7. The method of claim 5 wherein the third parameter does not depend on the fraction of response that has occurred.

8. The method of claim 2 wherein executing instructions further includes numerically integrating the differential equation over a range of elements, wherein the response is a system response composed of individual responses of each of the elements.

9. The method of claim 1 further comprising providing a database of values for parameters of the differential equation.

10. The method of claim 9 further comprising using the results of the numerical integration to produce an analysis of the stimulus-response system.

11. The method of claim 10 wherein the analysis is produced without disclosing at least one characteristic of the stimulus-response system.

12. The method of claim 1 wherein the response is a chemical reaction.

13. The method of claim 1 wherein the stimulus is radiation.

14. The method of claim 12 wherein the first parameter is a measure of the efficiency of the chemical reaction.

15. The method of claim 7 wherein the stimulus is radiation and the third parameter is the frequency of the radiation.

16. A machine-readable medium carrying instructions that, when executed by a machine, cause the machine to numerically integrate at least one differential equation that models a response to a stimulus, wherein the differential equation includes a first parameter that depends on the fraction of the response that has occurred.

17. The machine-readable medium of claim 16 wherein the instructions cause the machine to numerically integrate the differential equation over a second parameter with respect to which the fraction of the response varies.

18. The machine-readable medium of claim 17 wherein the second parameter is time.
